(19) United States
(12) Patent Application Publication
(10) Pub. No.: US 2026/0206721 A1
(43) Pub. Date: Jul. 23, 2026

(54) INTERACTIVE PET TOY

(71) Applicant: TANY TECHNOLOGY CO., LTD., Shenzhen (CN)

(72) Inventor: Yong LIN, Shenzhen (CN)

(73) Assignee: TANY TECHNOLOGY CO., LTD., Shenzhen, GD (CN)

(21) Appl. No.: 19/457,202

(22) Filed: Jan. 23, 2026

(30) Foreign Application Priority Data
Jan. 23, 2025 (CN) 202510114943.5

(51) Int. Cl. A01K 15/02

(52) U.S. Cl. CPC A01K 15/025

(57) ABSTRACT

The present invention relates to the technical field of pet toys, in particular to an interactive pet toy. The interactive pet toy includes a base assembly; the base assembly includes a base mount, a rotating base and a top housing assembly disposed on the base mount; the rotating base is rotatably disposed on the base mount and located between the base mount and the top housing assembly; an extension arm is disposed on the rotating base; the extension arm is detachably connected to the rotating base, and the extension arm is exposed outside the base assembly; a cover member is disposed on the top housing assembly, the cover member covers at least part of the area of the extension arm, light-emitting members are further disposed on the base mount, and/or the rotating base, and/or the extension arm, and light emitted by the light-emitting members on the extension arm are exposed through the cover member. The interactive pet toy attracts pets by the movement of the extension arm, meanwhile the interactive pet toy is further provided with a light-emitting member, so that light emitted by the light-emitting members can be exposed through the cover member, creating an effect that an object moves under the cover member, further arousing pets' curiosity, thereby improving the pet-interacting effect of the interactive pet toy.

### FIELD OF THE INVENTION

The present invention relates to the technical field of pet toys, in particular to an interactive pet toy.

### BACKGROUND OF THE INVENTION

With the popularization of pet keeping, the pet toy market has also boomed accordingly. Among various types of pet toys, interactive pet toys have attracted special attention for providing fun in interacting with pets. Most existing interactive pet toys are based on simple mechanical movements, for example, exposing an attractant out of a cover member through a rotating structure to attract pets' attention. However, traditional interactive pet toys only rely on mechanical movements to attract pets and lack diversified stimulation means such as sound and light effects. As time goes by, pets may lose interest in such monotonous stimulation, resulting in a shortened effective service life of the toys.

### SUMMARY OF THE INVENTION

In order to solve the problem that existing pet toys have relatively single means for attracting pets, the present invention provides an interactive pet toy.

To solve the above technical problems, the present invention provides the following technical solution: An Interactive Pet Toy, wherein it includes a base assembly; the base assembly includes a base mount, a rotating base and a top housing assembly disposed on the base mount; the rotating base is rotatably disposed on the base mount and located between the base mount and the top housing assembly, and an extension arm is disposed on the rotating base; a cover member is disposed on the top housing assembly, the cover member covers at least part of the area of the extension arm, light-emitting members are further disposed on the base mount and/or the rotating base and/or the extension arm, and light emitted by the light-emitting members on the extension arm is exposed through the cover member.

Compared with the prior art, the interactive pet toy provided by the present invention has the following beneficial effects:

1. The interactive pet toy provided by an embodiment of the present invention drives the extension arm to move via a transmission mechanism to attract pets, and is further provided with light-emitting members on the rotating base and/or the extension arm, so that light emitted by the light-emitting members can be exposed through the cover member, creating an effect that an object moves under the cover member, further arousing pets' curiosity, thereby improving the pet-interacting effect of the interactive pet toy. Specifically, the base mount in the solution serves as the base of the whole toy for carrying other structures. The rotating base rotatable relative to the base mount is arranged to realize a rotating function, so that the extension arm disposed on the rotating base can move together with the rotating base. The extension arm amplifies the movement amplitude of the rotating base, which can better attract pets. Configuring the extension arm as a detachable structure facilitates the overall storage and transportation of the interactive pet toy, and also allows the extension arm to be replaced as required. The cover member is arranged on the top housing assembly to cover at least part of the extension arm, so as to form a semi-covered state, which can better arouse pets' curiosity. Meanwhile, by arranging the light-emitting member on the base mount, and/or the rotating base, and/or the extension arm and combining movement and light emission, the attractiveness of the interactive pet toy to pets can be further enhanced. Moreover, the combination of movement and light emission enables the interactive pet toy with more working states, enabling the interactive pet toy to attract pets continuously.

### BRIEF DESCRIPTION OF THE DRAWINGS

FIG. 1 is a schematic structural view of the interactive pet toy provided by the first embodiment of the present invention with the cover member omitted.

FIG. 2 is a sectional view of the interactive pet toy provided by the first embodiment of the present invention.

FIG. 3 is an exploded view of the interactive pet toy provided by the first embodiment of the present invention.

FIG. 4 is an exploded view of the extension arm of the interactive pet toy provided by the first embodiment of the present invention.

FIG. 5 is a first schematic structural view of the base mount of the interactive pet toy provided by the first embodiment of the present invention.

FIG. 6 is a schematic structural view of a part of the interactive pet toy provided by the first embodiment of the present invention.

FIG. 7 is an exploded view of the drive assembly of the interactive pet toy provided by the first embodiment of the present invention.

FIG. 8 is an enlarged view of portion A in FIG. 2.

FIG. 9 is an exploded view of a part of the interactive pet toy provided by the first embodiment of the present invention.

FIG. 10 is a schematic assembly view of the base mount and the rotating base in the interactive pet toy provided by the first embodiment of the present invention.

FIG. 11 is a first top view of the interactive pet toy provided by the first embodiment of the present invention.

FIG. 12 is a second top view of the interactive pet toy provided by the first embodiment of the present invention.

FIG. 13 is a third top view of the interactive pet toy provided by the first embodiment of the present invention with the cover member omitted.

### EXPLANATION OF THE REFERENCE NUMERALS IN THE DRAWINGS

1. base assembly; 2. base mount; 21. drive mounting position; 211. motor bracket; 212. relief groove; 213. second support wall; 214. second connecting post; 22. connecting boss; 221. first support wall; 222. first connecting post; 24. outer protective layer; 25. inner protective layer; 26. annular limiting groove; 27. first gap; 28. second gap; 3. top housing assembly; 31. limiting bracket; 311. first limiting step; 312. relief step; 313. second limiting step; 314. fixing plate; 3141. fixing protrusion; 32. mounting chamber; 33. second circuit board; 34. fixing cover; 35. decorative cover; 4. rotating base; 41. limiting plate; 5. extension arm; 51. housing assembly; 511. first detachable structure; 512. light-emitting aperture; 52. power supply; 53. first circuit board; 531. switch; 532. charging port; 54. light-emitting member; 55. attractant; 551. second detachable structure; 6. cover member; 61. transparent or translucent region; 62. notch; 7. drive assembly; 71. motor; 72. first gear; 73. pulley assembly; 74. first mounting portion; 75. second mounting portion; 8. inner bracket assembly; 81. support frame; 82. drive bracket; 821. second gear; 83. bearing.

### DETAILED DESCRIPTION OF THE INVENTION

To make the objectives, technical solutions, and advantages of the present invention clearer, the present invention will be further described in detail below with reference to the accompanying drawings and embodiments. It should be understood that the specific embodiments described herein are only used to explain the present invention and are not intended to limit the present invention.

In the embodiments provided by the present invention, it should be understood that “B corresponding to A” means that B is associated with A, and B can be determined according to A. However, it should also be understood that determining B according to A does not mean that B is determined only according to A, and B can also be determined according to A and/or other information.

It should be understood that reference to “one embodiment” or “an embodiment” throughout the specification means that a specific feature, structure, or characteristic related to the embodiment is included in at least one embodiment of the present invention. Therefore, the appearance of “in one embodiment” or “in an embodiment” in various places throughout the specification does not necessarily refer to the same embodiment. In addition, these specific features, structures, or characteristics can be combined in any suitable manner in one or more embodiments. Those skilled in the art should also know that the embodiments described in the specification are all optional embodiments, and the actions and modules involved are not necessarily required by the present invention.

In various embodiments of the present invention, it should be understood that the sequence numbers of the above processes do not necessarily mean the order of execution, and the order of execution of each process should be determined by its function and internal logic, and should not constitute any limitation on the implementation process of the embodiments of the present invention.

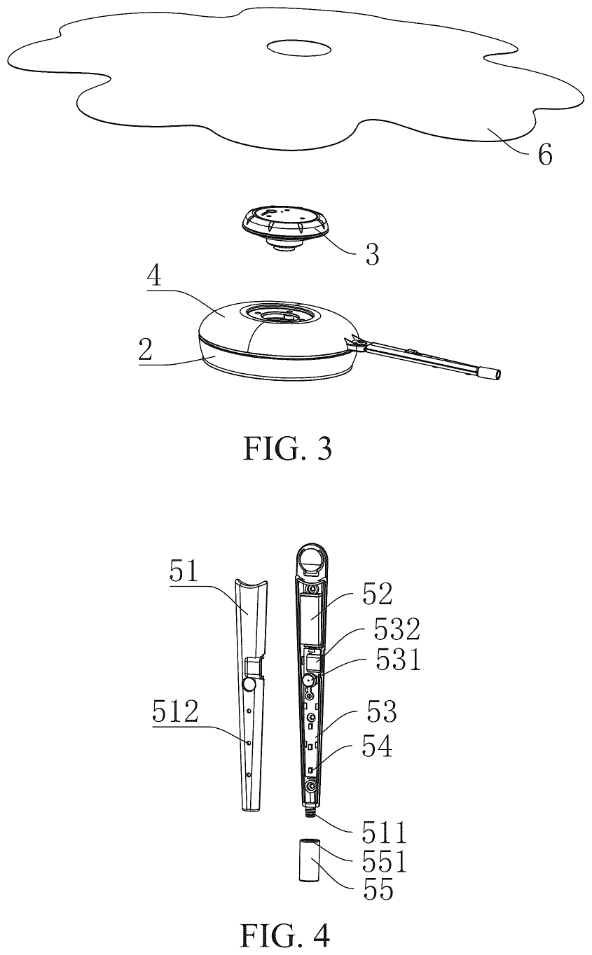

Please refer to FIGS. 1 to 3 and FIG. 12. A first embodiment of the present invention provides an interactive pet toy, and the interactive pet toy includes a base assembly 1. The base assembly 1 includes a base mount 2 and a top housing assembly 3 disposed on the base mount 2. The base assembly 1 further includes a rotating base 4, the rotating base 4 is rotatably disposed on the base mount 2 and located between the base mount 2 and the top housing assembly 3. An extension arm 5 is disposed on the rotating base 4, and the extension arm 5 is exposed out of the base assembly 1. A cover member 6 is disposed on the top housing assembly 3, and the cover member 6 covers at least part of the extension arm 5. Light-emitting members 54 are further disposed on the base mount 2 and/or the rotating base 4 and/or the extension arm 5, and light emitted by the light-emitting members 54 on the extension arm 5 is exposed through the cover member 6.

It can be understood that the interactive pet toy provided by the embodiment of the present invention drives the extension arm 5 to move via a transmission mechanism so as to attract pets. Meanwhile, the light-emitting members 54 are arranged on the extension arm 5, and light emitted by the light-emitting members 54 can be exposed through the cover member 6, creating an effect that an object moves under the cover member 6, further arousing the curiosity of pets, thereby improving the interactive effect of the interactive pet toy.

Specifically, the base mount 2 in the present embodiment serves as the base of the whole interactive pet toy, for carrying other structures. The rotating base 4 rotatable relative to the base mount 2 is arranged to realize a rotating function, so that the extension arm 5 disposed on the rotating base 4 can move together with the rotating base 4. The extension arm 5 amplifies the movement amplitude of the rotating base 4, which can better attract pets. The cover member 6 is arranged on the top housing assembly 3, and covers at least part of the extension arm 5 to achieve a semi-covered state, which can better arouse the curiosity of pets. Meanwhile, the light-emitting members 54 are arranged on the rotating base 4 and/or the extension arm 5. When the rotating base 4 and/or the extension arm 5 rotates, moving light spots or light tracks are formed by combining movement and light emission, which can further enhance the attractiveness of the interactive pet toy to pets. Moreover, the combination of movement and light emission enables the interactive pet toy with more working states, enabling the interactive pet toy to attract pets continuously.

It should be noted that when the light-emitting members 54 are arranged on the base mount 2, it can be disposed on the outer surface of the base mount 2 or inside the base mount 2. When the light-emitting members 54 are disposed inside the base mount 2, light-transmitting structures need to be arranged on the rotating base 4.

Specifically, the light-transmitting structure can be a light-transmitting hole, or a light-transmitting layer made of a material such as glass or plastic.

Specifically, in the present embodiment, the interactive pet toy is placed on an external placement surface via the base mount 2, and the rotating base 4 and the top housing assembly 3 are located above the base mount 2.

In one embodiment, the extension arm 5 is detachably connected to the rotating base 4.

It can be understood that configuring the extension arm 5 as a detachable structure facilitates the overall storage and transportation of the interactive pet toy, and also allows the extension arm 5 to be replaced as required.

In one embodiment, the extension arm 5 and the rotating base 4 are of an integrated structure. It can be understood that this design simplifies the production process, reduces manufacturing costs and assembly difficulty. Furthermore, because there is no detachable connection point, the integrated structure reduces relative movement between components, thereby lowering the risk of wear.

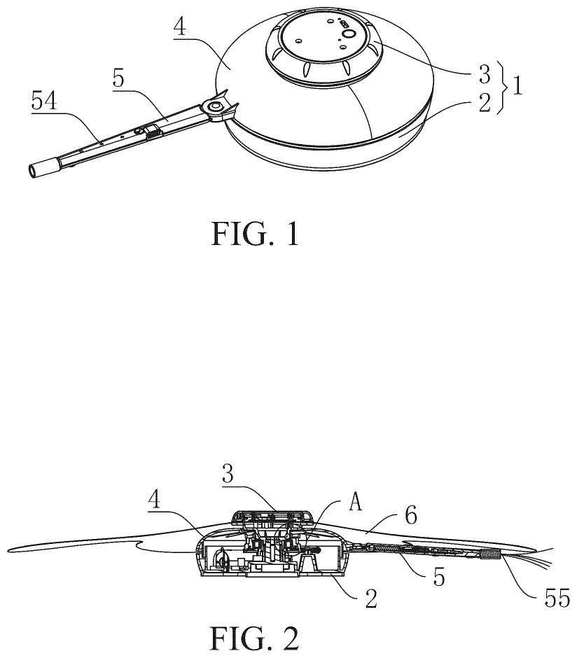

Please refer to FIG. 1 and FIG. 2, in one embodiment, a plurality of light-emitting members 54 are disposed on the extension arm 5, and the plurality of light-emitting members 54 are arranged along a length direction of the extension arm 5. An attractant 55 is disposed at an end of the extension arm 5 away from the base assembly 1, and the attractant 55 is exposed from at least part of the cover member 6 as the rotating base 4 rotates.

It can be understood that, in the embodiment of the present invention, disposing a plurality of light-emitting members 54 on the extension arm 5 can create more diverse light-emitting states, and arranging the light-emitting members 54 along the length direction of the extension arm 5 can make better use of space and enrich the light changing effect. Disposing the attractant 55 at an end of the extension arm 5 provides a physical attractant, which can better attract pets. As the rotating base 4 rotates, whether the attractant 55 is kept exposed or appears and hides alternately can effectively arouse the curiosity of pets.

It should be noted that the number of the light-emitting members 54 can be simply changed, and in other embodiments, only one light-emitting member 54 may be disposed.

In one embodiment, a plurality of light-emitting members 54 are disposed on the rotating base 4, and the plurality of light-emitting members 54 are arranged along a circumferential direction of the rotating base 4. It can be understood that the plurality of light-emitting members 54 arranged along the circumferential direction of the rotating base form a continuous ring of light bands or light spots during rotation, creating a dynamic and eye-catching visual effect. Such a surrounding light effect can attract pets' attention more effectively, imitate annular light sources in nature (such as firefly swarms), and stimulate pets' curiosity and desire to explore.

It should be noted that arranging the plurality of light-emitting members 54 along the length direction of the extension arm 5 can generate dynamically changing light effects when the pet toy operates, and such light changes can attract pets' attention, thereby more naturally arousing pets' curiosity and chasing instinct. When the rotating base 4 rotates, the extension arm 5 located on the circumferential outer surface of the rotating base 4 and the light-emitting members 54 on the extension arm 5 form continuous light tracks, which can help guide pets' eyes to follow the paths and increase the fun and challenge of the game. The diversified arrangement of the light-emitting members 54 can create different visual effects, such as light modes of flickering, gradient or flowing, which not only increase the interest and uncertainty of the toy, but also encourage pets to interact with the toy more actively and improve pets' participation.

It can be understood that the attractant 55, as a component directly interacting with pets, can provide a specific and physical target for pets to chase or play with. Disposing the attractant 55 at an end of the extension arm 5 away from the base assembly 1 takes advantage of the space of the whole device and avoids the structural complexity caused by centralized arrangement. Meanwhile, such a layout also ensures that the attractant 55 has a sufficient movement range during rotation without interfering with other parts.

In one embodiment, the attractant 55 includes a fixing member and a toy body, and the toy body is disposed on the fixing member and connected to the extension arm 5 via the fixing member.

Optionally, the toy body includes at least one of feathers, wool, ropes and dolls.

In one embodiment, some attractants 55 may be internally provided with a sound module, a vibration module or other sensory stimulation devices, and when a sound module, a vibration module or other sensory stimulation devices are arranged at the end of the extension arm 5, richer and more diverse interaction scenarios can be created by combining mechanical movement and light-emitting effects, realizing functional integration and expansion.

Referring to FIG. 4, in one embodiment, the extension arm 5 includes a housing assembly 51, a power supply 52 and a first circuit board 53 that are electrically connected are disposed in the housing assembly 51, the light-emitting members 54 are disposed on the first circuit board 53, and light-emitting apertures are disposed on the housing assembly 51 corresponding to the light-emitting members 54. A first detachable structure 511 is disposed at an end of the extension arm 5 away from the base assembly 1, a second detachable structure 551 is disposed on the attractant 55, and the extension arm 5 and the attractant 55 are detachably connected via the first detachable structure 511 and the second detachable structure 551.

It can be understood that, in the embodiment of the present invention, disposing the first circuit board 53 in the extension arm 5 can better control the light-emitting effects of the light-emitting members 54, and facilitates presetting parameters such as light-emitting color, brightness or flickering frequency in advance. Meanwhile, separately disposing the power supply 52 in the extension arm 5 eliminates the need for electrical connection between the extension arm 5 and the base assembly 1, further facilitating the assembly and disassembly of the extension arm 5. Besides, the extension arm 5 and the attractant 55 can be detachably connected via the first detachable structure 511 and the second detachable structure 551, which facilitates storage and replacement of different attractants 55. The Interactive pet toy has high applicability.

It should be noted that in the present embodiment, the power supply 52, the first circuit board 53 and the light-emitting members 54 are integrated inside the housing assembly 51, so that these key components are protected, the influence of the external environment on them is reduced, and regular maintenance or replacement by users is facilitated. The power supply 52 is directly installed inside the extension arm 5 and connected to the first circuit board 53, eliminating the need for complex wire connection from the base to the extension arm 5 in traditional designs, reducing assembly difficulty and fault points, and improving the stability and reliability of the system. The light-emitting members 54 on the first circuit board 53 can realize various light effects through preset programs, such as gradient, chasing, random flickering and the like, which not only enrich the visual experience, but also reserve interfaces for subsequent function expansion, for example, docking with intelligent devices through wireless communication technology to realize remote control.

In one embodiment, a switch 531 and a charging port 532 are further disposed on the first circuit board 53, and the switch 531 and the charging port 532 are respectively exposed through the housing assembly 51. Users can separately charge and control the extension arm 5.

In one embodiment, the switch 531 and the charging port 532 are exposed on different surfaces of the housing assembly 51.

In one embodiment, the switch 531 and the light-emitting members 54 are exposed on the same side of the housing assembly 51.

Specifically, the housing assembly 51 includes a first housing and a second housing, and the power supply 52 and the first circuit board 53 are sandwiched between the first housing and the second housing. Light-emitting apertures are disposed on the first housing corresponding to the light-emitting members 54, and the first detachable structure 511 is disposed at an end of the second housing.

Optionally, one of the first detachable structure 511 and the second detachable structure 551 is a threaded post, and the other is a threaded hole; and/or, one of the first detachable structure 511 and the second detachable structure 551 is a locking boss, and the other is a locking groove.

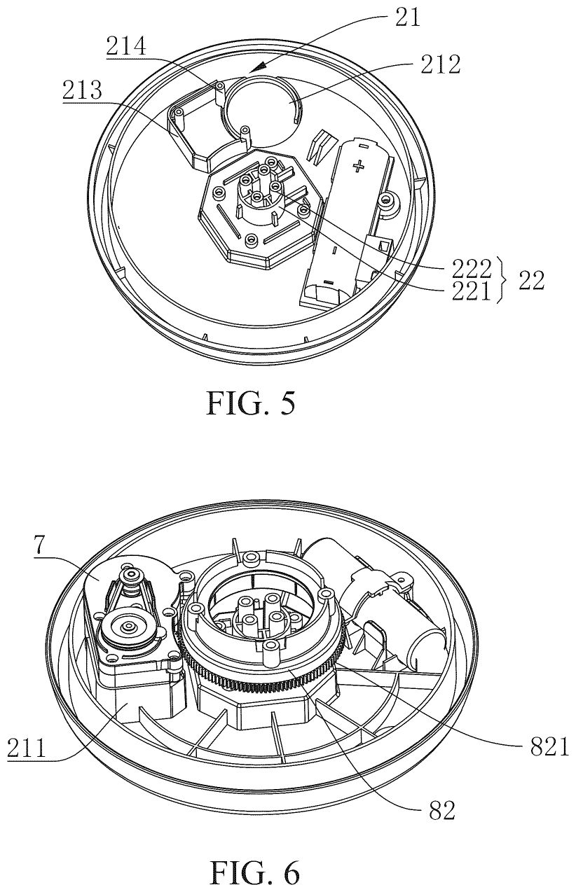

With reference to FIG. 5 to FIG. 7, in one embodiment, a drive assembly 7 and an inner bracket assembly 8 are further disposed in the base mount 2. The drive assembly 7 includes a motor 71 and a transmission assembly, the inner bracket assembly 8 includes a support frame 81 and a drive bracket 82, the support frame 81 and the drive bracket 82 are rotatably connected via a bearing 83, the motor 71 is in transmission connection with the support frame 81 via the transmission assembly, and the rotating base 4 is disposed on the drive bracket 82.

It can be understood that, in the embodiment of the present invention, the rotating base 4 is driven to rotate through cooperation of the motor 71, the transmission assembly and the drive bracket 82, wherein the support frame 81 can well support the drive bracket 82 and reduce looseness or damage caused by external impact or long-term use, and the drive bracket 82 provides an installation position for the rotating base 4. Disposing the bearing 83 between the support frame 81 and the drive bracket 82 can enable the smoother rotation of the drive bracket 82, which is conducive to ensuring the working stability of the interactive pet toy.

In one embodiment, the transmission assembly includes a first gear 72, a drive mounting position 21 is disposed on the base mount 2, the drive mounting position 21 includes a motor bracket 211, a second gear 821 is disposed on the circumferential outer surface of the drive bracket 82, the motor 71 is in transmission connection with the first gear 72, and the first gear 72 is meshed with the second gear 821.

It can be understood that, in the embodiment of the present invention, by disposing the second gear 821 on the circumferential outer surface of the drive bracket 82, meshing can be completed only by arranging the first gear 72 close to the drive bracket 82 from the outer side, which facilitates assembly. Meanwhile, disposing the motor bracket 211 directly in the base mount 2 facilitates positioning and installation of the motor 71.

In one embodiment, the transmission assembly further includes a pulley assembly 73, and the motor 71 and the first gear 72 are in transmission connection via the pulley assembly 73. It can be understood that the application of the pulley assembly 73 ensures smooth and accurate power transmission from the motor 71 to the first gear 72. As a reduction assembly, the pulley assembly 73 can effectively reduce the rotating speed output by the motor 71, increase the output torque, and realize a speed reduction function. The pulley has good tensile strength and elasticity, and can reduce vibration and noise while maintaining synchronization, so as to ensure smoother and more natural movement of the rotating base 4 and the extension arm 5. Compared with the direct gear meshing transmission in the traditional art, the pulley assembly 73 provides a large adjustment range of center distance, so that the distance between the motor 71 and the first gear 72 can be flexibly adjusted according to actual needs, increasing design flexibility. Meanwhile, energy loss can be reduced and transmission efficiency can be improved. The pulley assembly 73 can more effectively transmit the power of the motor 71 to the first gear 72, so as to drive the whole system to work and reduce unnecessary energy waste.

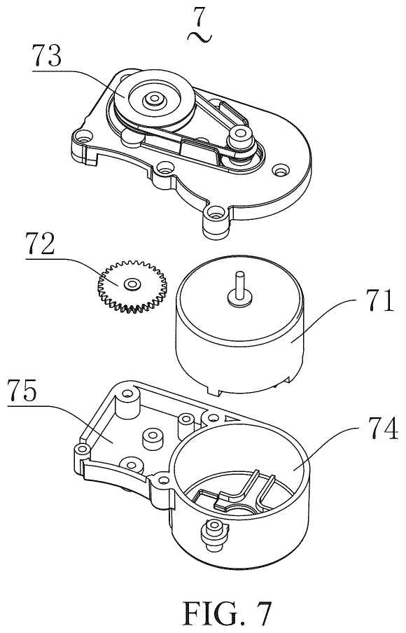

With continued reference to FIG. 7, in one embodiment, the drive assembly 7 further includes a mounting case, the mounting case includes a first mounting portion 74 and a second mounting portion 75 that are connected, an overall thickness of the second mounting portion 75 is smaller than an overall thickness of the first mounting portion 74, the motor 71 is disposed in the first mounting portion 74, the first gear 72 is disposed in the second mounting portion 75, and part of the first gear 72 is exposed from the second mounting portion 75.

The motor bracket 211 includes a relief groove 212, a second support wall 213 and a second connecting post 214, at least part of the first mounting portion 74 is located in the relief groove 212, the second support wall 213 abuts against the second mounting portion 75, and the second connecting post 214 is fixedly connected to the mounting case.

It can be understood that, in the embodiment of the present invention, the motor 71 and the first gear 72 with different thicknesses are separately disposed on the first mounting portion 74 and the second mounting portion 75, and the corresponding relief groove 212 and support wall are disposed in the base mount 2, so that the space utilization rate is higher and the structural stability is better.

With continued reference to FIG. 5, in one embodiment, a connecting boss 22 is disposed in the base mount 2, the connecting boss 22 includes a first support wall 221 and a first connecting post 222 disposed in the first support wall 221, the support frame 81 is sleeved on the first support wall 221, an inner race of the bearing 83 is sleeved on the support frame 81, the drive bracket 82 is sleeved on an outer race of the bearing 83, the rotating base 4 is disposed on a top surface of the drive bracket 82, and an end of the top housing assembly 3 passes through the rotating base 4 and is fixedly connected to the first connecting post 222.

It can be understood that, in the embodiment of the present invention, the first support wall 221 can provide support for the first connecting post 222 disposed inside thereof and the support frame 81 sleeved outside thereof, so as to improve the structural stability and working stability of the interactive pet toy. Disposing the rotating base 4 on the top surface of the drive bracket 82 can effectively prevent the rotating base 4 from interfering with the support frame 81, the bearing 83 and other structures below during rotation, which is conducive to ensuring the smoothness of rotation.

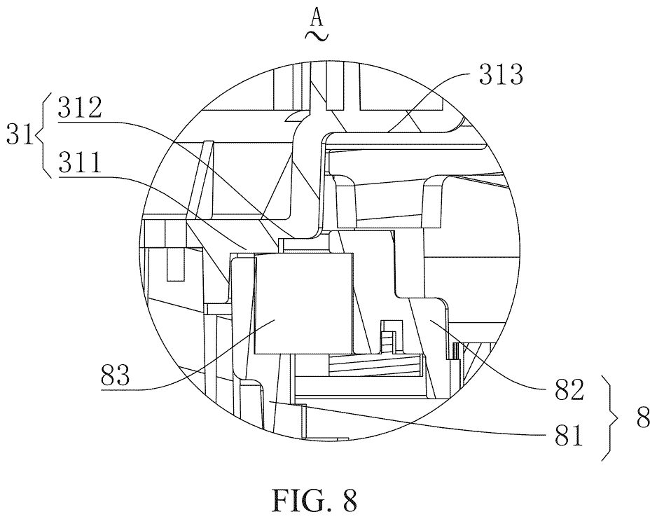

With continued reference to FIG. 8, in one embodiment, a first limiting step 311, a relief step 312 and a second limiting step 313 are sequentially disposed on the limiting bracket 31 in a direction away from the base mount 2. The limiting bracket 31 abuts against the inner race of the bearing 83 via the first limiting step 311, the relief step 312 is arranged corresponding to balls of the bearing 83, and the second limiting step 313 is arranged corresponding to the rotating base 4.

It can be understood that the design of multiple steps ensures accurate relative positions among all components, and avoids function failure or mechanical faults caused by assembly errors. Meanwhile, the first limiting step 311 abuts against the inner race of the bearing 83, which can better ensure the connection stability between the bearing 83 and the support frame 81, provide stable axial support, and keep the concentricity of the rotating base 4 during rotation. The relief step 312 avoiding the balls of the bearing 83 can prevent interference with the operation of the bearing 83, so as to ensure smooth rotation of the drive bracket 82 and the extension arm 5. The second limiting step 313 arranged corresponding to the rotating base 4 can limit the rotating base 4 and prevent vertical polarization of the rotating base 4 during rotation.

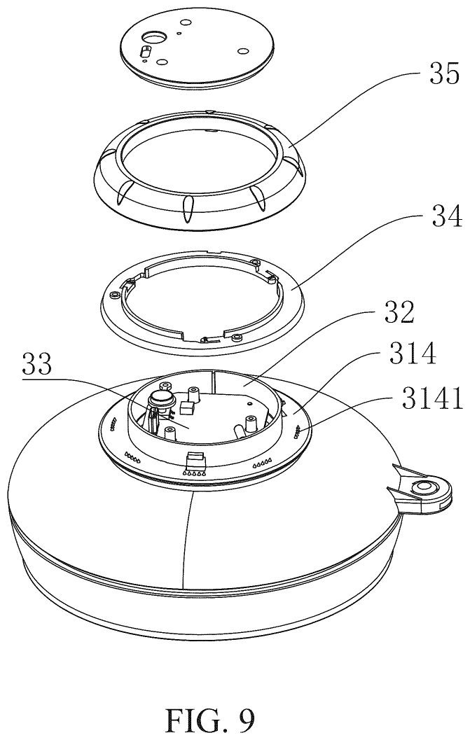

Referring to FIG. 9, in one embodiment, a fixing plate 314 is disposed at an end of the top housing assembly 3 away from the base assembly 1, and the rotating base 4 is located between the fixing plate 314 and the base mount 2. Through holes are formed on the fixing plate 314 and the cover member 6, the cover member 6 is sleeved on the top housing assembly 3 through the through holes, and an edge of the cover member 6 close to the through holes is connected to the fixing plate 314.

It can be understood that, in the embodiment of the present invention, the cover member 6 is fixed by the corresponding fixing plate 314, which can prevent the cover member 6 from rotating together with the extension arm 5 or disengaging, and further enhances the working stability of the interactive pet toy.

In one embodiment, the top housing assembly 3 further includes a fixing cover 34 covering the fixing plate 314, and part of the cover member 6 is sandwiched between the fixing plate 314 and the fixing cover 34.

It can be understood that sandwiching the cover member 6 between the fixing plate 314 and the fixing cover 34 can effectively prevent the cover member 6 from shifting or falling off during rotation or pet playing, and ensure that the cover member 6 is always in a correct position.

In one embodiment, a mounting chamber 32 is further disposed at an end of the limiting bracket 31 away from the base mount 2, a second circuit board 33 is disposed in the mounting chamber 32, the second circuit board 33 is electrically connected to the drive assembly 7, and a control switch is disposed on the second circuit board 33. The fixing plate 314 is arranged around the mounting chamber 32.

It can be understood that integrating the control switch on the second circuit board 33 and arranging the second circuit board 33 inside the top housing assembly 3 through the mounting chamber 32 allows users to perform simple operations to control functions of the toy, such as starting, stopping or switching modes, improving use convenience. Disposing the second circuit board 33 in the mounting chamber 32 makes full use of limited space resources, contributes to lightweight and miniaturized design of the product, and maintains sufficient strength and rigidity at the same time.

In one embodiment, fixing protrusions 3141 are disposed on the fixing plate 314. When the cover member 6 is sandwiched between the fixing plate 314 and the fixing cover 34, the fixing protrusions 3141 on the fixing plate 314 press the cover member 6 against the fixing cover 34.

In one embodiment, the fixing cover 34 is locked to the fixing plate 314 via connecting members.

Optionally, the fixing protrusions 3141 are in a shape of a column, an arc or a cone.

In one embodiment, a decorative cover 35 is further disposed on the fixing plate 314, and the decorative cover 35 shields the fixing cover 34.

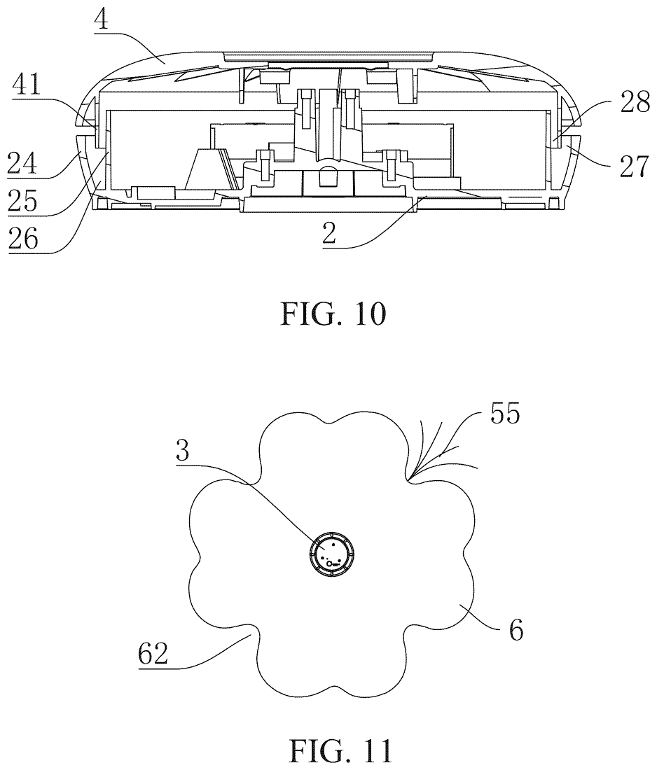

Referring to FIG. 10, in one embodiment, an outer protective layer 24 and an inner protective layer 25 are disposed on an outer periphery of the base mount 2, an annular limiting groove 26 is formed between the outer protective layer 24 and the inner protective layer 25, a limiting plate 41 is disposed on an outer edge of the rotating base 4, and the limiting plate 41 is located in the annular limiting groove 26. When the rotating base 4 rotates, the limiting plate 41 moves in the annular limiting groove 26. A first gap 27 is formed between the outer protective layer 24 and the limiting plate 41, a second gap 28 is formed between the limiting plate 41 and the inner protective layer 25, and the first gap 27 and the second gap 28 are communicated through a bottom of the annular limiting groove 26.

It can be understood that, in the embodiment of the present invention, the annular limiting groove 26 formed by the outer protective layer 24 and the inner protective layer 25 limits the limiting plate 41, which can effectively limit the rotating base 4 and prevent the rotating base 4 from deflecting, thereby further ensuring the working stability of the interactive pet toy. At the same time, the cooperation of the first gap 27, the second gap 28 and the annular limiting groove 26 creates a tortuous path between the inner space of the mount 2 and the external environment, which can effectively prevent external impurities from entering the base mount 2 and is conducive to prolonging the service life of the interactive pet toy.

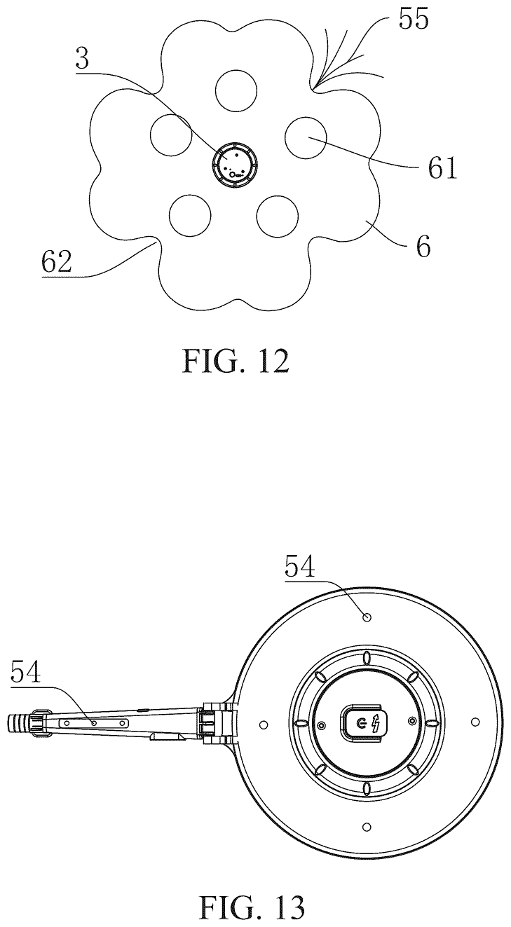

With reference to FIG. 11 and FIG. 12, in one embodiment, part of the cover member 6 is configured as a transparent or translucent region 61, and the light-emitting members 54 and/or the attractant 55 are visible through the transparent or translucent region 61, and/or at least one notch 62 is disposed in part of the cover member 6, and the light-emitting members 54 and/or the attractant 55 are exposed through the at least one notch 62.

It can be understood that arranging the transparent or translucent regions 61 can create an effect of interlaced light and shadow. When the light-emitting members 54 are lit, light is emitted through these regions to form soft and mysterious light effects, which greatly enhances visual attractiveness. Moreover, the transparent or translucent materials helps to optimize the light quality emitted by the light-emitting members 54. The at least one notch 62 allows part or all of the attractant 55 to be exposed, which increases physical visibility and accessibility, and directly attracts pets' attention. The transparent or translucent regions 61 and the at least one notch 62 with different positions and shapes can be combined to produce diverse visual effects, meet the preferences of different pets, and provide a richer playing experience.

In one embodiment, the cover member 6 is a flexible member. It can be understood that the flexible cover member 6 can swing or deform naturally with the movement of the attractant 55 or the extension arm 5, which increases dynamic changes, and thus stimulates pets' curiosity and desire to explore. Compared with rigid materials, the flexible cover member 6 is friendlier to pets and will not cause injuries even if collisions occur during playing. Especially for young or lively pets, the flexible cover member 6 provides additional safety protection.

Optionally, the cover member 6 can be made of fabric materials such as cotton cloth, nylon or mesh cloth, and can also be made of synthetic materials such as PVC or TPU.

With reference to FIG. 1 to FIG. 12, the working process/principle of the interactive pet toy provided by the present embodiment is briefly described as follows: Press the control switch disposed in the mounting chamber 32 at the end of the limiting bracket 31 away from the base mount 2 to supply power to the whole system and activate a preset program on the second circuit board 33. Then, the motor 71, as a main power source, starts to operate and transmits power to the bearing 83 on the support frame 81 via the transmission assembly, driving the drive bracket 82 and the rotating base 4 thereon to rotate synchronously. The detachable extension arm 5 connected to the rotating base 4 moves accordingly and amplifies the movement amplitude to attract pets' attention. A power supply 52 and a first circuit board 53 that are electrically connected are disposed in the extension arm 5, and a plurality of light-emitting members 54 are arranged along the length direction of the extension arm 5 and emit light under the control of the first circuit board 53. The light is emitted through the cover member 6 made of partially transparent or translucent material on the top housing assembly 3 to create varied light and shadow effects. At the same time, an attractant 55 is disposed at an end of the extension arm 5 away from the base assembly 1, and is periodically exposed from part of the cover member 6 as the rotating base 4 rotates, simulating a “hide-and-seek” game scenario to arouse pets' curiosity. The cover member 6 is made of a flexible material and is sandwiched and fixed by the fixing plate 314 and the fixing cover 34 to ensure stability without displacement. The annular limiting groove 26 formed by the outer protective layer 24 and the inner protective layer 25 effectively limits the rotating base 4 to prevent deflection, blocks external impurities from entering, and prolongs the service life.

The interactive pet toy disclosed in the embodiments of the present invention has been introduced in detail above. Specific examples are used herein to explain the principle and implementations of the present invention. The descriptions of the above embodiments are only used to help understand the method of the present invention and its core idea. At the same time, for those skilled in the art, according to the idea of the present invention, there will be changes in the specific implementations and application scopes. In conclusion, the contents of this specification shall not be construed as limiting the present invention. Any modifications, equivalent replacements, improvements and the like made within the principle of the present invention shall all be included in the protection scope of the present invention.

1. Interactive pet toy comprising a base assembly;
the base assembly comprises a base mount, a rotating base and a top housing assembly disposed on the base mount;
the rotating base is rotatably disposed on the base mount and located between the base mount and the top housing assembly;
an extension arm is disposed on the rotating base;
a cover member is disposed on the top housing assembly, the cover member covers at least part of the area of the extension arm, light-emitting members are further disposed on the base mount and/or the rotating base and/or the extension arm, and light emitted by the light-emitting members on the extension arm is exposed through the cover member.

2. The interactive pet toy according to claim 1, wherein a plurality of light-emitting members are disposed on the extension arm, and the plurality of light-emitting members are arranged along a length direction of the extension arm; an attractant is disposed at an end of the extension arm away from the base assembly, and the attractant is exposed from at least part of the cover member as the rotating base rotates.

3. The interactive pet toy according to claim 2, wherein the extension arm is detachably connected to the rotating base, the extension arm comprises a housing assembly; and a power supply and a first circuit board that are electrically connected are disposed in the housing assembly, the light-emitting members are disposed on the first circuit board, and light-emitting apertures are disposed on the housing assembly corresponding to the light-emitting members; a first detachable structure is disposed at an end of the extension arm away from the base assembly, a second detachable structure is disposed on the attractant, and the extension arm and the attractant are detachably connected via the first detachable structure and the second detachable structure.

4. The interactive pet toy according to claim 3, wherein a switch and a charging port are further disposed on the first circuit board, and the switch and the charging port are exposed through the housing assembly respectively.

5. The interactive pet toy according to claim 3, wherein the housing assembly comprises a first housing and a second housing, the power supply and the first circuit board are sandwiched between the first housing and the second housing; light-emitting apertures are disposed on the first housing corresponding to the light-emitting members, and the first detachable structure is disposed at an end of the second housing.

6. The interactive pet toy according to claim 3, wherein one of the first detachable structure and the second detachable structure is a threaded post, and the other is a threaded hole; or, one of the first detachable structure and the second detachable structure is a locking boss, and the other is a locking groove.

7. The interactive pet toy according to claim 2, wherein a sound module or a vibration module is disposed in the attractant.

8. The interactive pet toy according to claim 1, wherein a plurality of the light-emitting members are disposed on the rotating base, and the plurality of light-emitting members are arranged along a circumferential direction of the rotating base.

9. The interactive pet toy according to claim 1, wherein a drive assembly and an inner bracket assembly are disposed in the base mount, the drive assembly comprises a motor and a transmission assembly, the inner bracket assembly comprises a support frame and a drive bracket, the support frame and the drive bracket are rotatably connected via a bearing, the motor is in transmission connection with the support frame via the transmission assembly, and the rotating base is disposed on the drive bracket.

10. The interactive pet toy according to claim 9, wherein the transmission assembly comprises a first gear; a drive mounting position is disposed on the base mount, the drive mounting position comprises a motor bracket, a second gear is disposed on a circumferential outer surface of the drive bracket, the motor is in transmission connection with the first gear, and the first gear is meshed with the second gear.

11. The interactive pet toy according to claim 9, wherein a connecting boss is disposed in the base mount, the connecting boss comprises a first support wall and a first connecting post disposed in the first support wall, the support frame is sleeved on the first support wall, an inner race of the bearing is sleeved on the support frame, the drive bracket is sleeved on an outer race of the bearing, the rotating base is disposed on a top surface of the drive bracket, and an end of the top housing assembly passes through the rotating base and is fixedly connected to the first connecting post.

12. The interactive pet toy according to claim 10, wherein the transmission assembly further comprises a pulley assembly, and the motor is in transmission connection with the first gear via the pulley assembly.

13. The interactive pet toy according to claim 12, wherein the drive assembly further comprises a mounting case, the mounting case comprises a first mounting portion and a second mounting portion that are connected, a thickness of the second mounting portion is smaller than a thickness of the first mounting portion, the motor is disposed in the first mounting portion, the first gear is disposed in the second mounting portion, and part of the first gear is exposed from the second mounting portion;
the drive mounting position further comprises a relief groove, a second support wall and a second connecting post, at least part of the first mounting portion is located in the relief groove, the second support wall abuts against the second mounting portion, and the second connecting post is fixedly connected to the mounting case.

14. The interactive pet toy according to claim 1, wherein a fixing plate is disposed at an end of the top housing assembly away from the base assembly, and the rotating base is located between the fixing plate and the base mount; through holes are disposed on the fixing plate and the cover member, the cover member is sleeved on the top housing assembly through the through holes, and an edge of the cover member close to the through holes is connected to the fixing plate.

15. The interactive pet toy according to claim 1, wherein an outer protective layer and an inner protective layer are disposed on an outer periphery of the base mount, an annular limiting groove is formed between the outer protective layer and the inner protective layer, a limiting plate is disposed on an outer edge of the rotating base, and the limiting plate is located in the annular limiting groove; when the rotating base rotates, the limiting plate moves in the annular limiting groove; a first gap is formed between the outer protective layer and the limiting plate, a second gap is formed between the limiting plate and the inner protective layer, and the first gap and the second gap are communicated through a bottom of the annular limiting groove.

16. The interactive pet toy according to claim 1, wherein the cover member is a flexible member.

17. The interactive pet toy according to claim 2, wherein part of the cover member is configured as a transparent or translucent region, and the light-emitting members and/or the attractant are visible through the transparent or translucent region; and/or, at least one notch is disposed in part of the cover member, and the light-emitting members and/or the attractant is exposed through the at least one notch.
